(19) United States
(12) Patent Application Publication
(10) Pub. No.: US 2017/0057114 A1
(43) Pub. Date: Mar. 2, 2017

(54) PLANER WITH AXIALLY SHIFTABLE PLANING HEAD

(71) Applicant: Kimwood Corporation, Cottage Grove, OR (US)

(72) Inventor: Kenneth S. Pfeiffer, Springfield, OR (US)

(73) Assignee: Kimwood Corporation, Cottage Grove, OR (US)

(21) Appl. No.: 14/838,159

(22) Filed: Aug. 27, 2015

(51) Int. Cl. B27C 1/08; B27C 1/14

(52) U.S. Cl. CPC B27C 1/08; B27C 1/14

(57) ABSTRACT

A planer for lumber comprises a support and at least one planing head rotatably mounted to the support. The at least one planing head has a rotation axis and is controllably shiftable to move from a first cutting position at a first axial position to a second cutting position at a second axial position. Methods and a planing head for a planer are also described.

### FIELD

This application relates to planers, and in particular to a new approach to moving planing heads to keep planers in service.

### BACKGROUND

Planers typically have multiple rotating planing heads (also referred to as cutterheads). Each planing head has multiple parallel blades and is rotated at high speed to finish workpieces, such as lumber. Such planing operations are used, e.g., to smoothen rough surfaces. Over time, planing head blades eventually become dull from use and need to be re-sharpened. Re-sharpening the planing head blades helps to ensure that the resulting surface of the workpiece is uniform.

In some cases, the planing head blades can be sharpened while they remain installed on the planing head in a process known as “jointing.” In other cases, the planing head blades must be removed from the planing head for a more extensive re-sharpening operation referred to as regrinding the bevel.

In still other cases, blades that are damaged, such as from contacting a foreign object in the workpiece, or blades that have been worn beyond their serviceable life, cannot be re-sharpened and therefore must be replaced.

Re-sharpening or replacing blades requires that the planer is shut down and that the planing heads are at rest. These operations require considerable downtime because of the size of the equipment, the need for specialized personnel and tools, and the need to ensure worker safety, among other factors. Similarly, even swapping a new planing head for a current head requires significant downtime. Because planer equipment is expensive to own and operate, it is typically not cost effective to have multiple planers with one or more held in reserve until needed.

It would be desirable to provide alternatives to the conventional ways of keeping planers in service that require substantial downtime.

### SUMMARY

Described below are implementations of a planer, a planing head and methods that reduce the amount of service time required for repair when a planing head becomes dull or damaged.

According to a first implementation, a planer for lumber comprises a support and at least one planing head rotatably mounted to the support. The planing head is positionable to contact a surface of a workpiece. The planing head has a rotation axis and is shiftable from a first cutting position at a first axial position to a second cutting position at second axial position. In this way, if the first cutting position (or region) becomes dull or damaged, the planing head can be shifted axially along the rotation axis to the second cutting position (or region). As a result, there is a substantial time savings because a complete replacement of the planing head or a re-sharpening of blades in the first cutting position is not required.

In some implementations, the shifting from the first cutting position at the first axial position to the second cutting position at the second axial position includes motion along only the rotation axis. In other implementations, the shifting from the first cutting position to the second cutting position includes a component along or parallel to the rotation axis, but also includes one or more other components offset from the rotation axis, such as a radial component or other component in a direction away from the rotation axis.

The at least one planing head can be a first planing head, and the planer can further comprise a second planing head. The first and second planing heads can be shiftable axially along respective first and second rotation axes from respective first cutting positions to respective second cutting positions. The first planing head and the second planing head can be independently shiftable relative to each other.

There can be a first planing head and a second planing head that form a first axially shiftable planing head pair, and there can be a second axially shiftable planing head pair. The rotation axes for the second axially shiftable planing head pair can have an orientation that is not parallel to rotation axes for the first axially shiftable planing head pair. The first axially shiftable planing head pair can comprise a top planing head and a bottom planing head, and the second axially shiftable planing head pair can comprise side planing heads.

The planer can comprise a movement device coupled to the at least one planing head and controllable to shift the at least one planing head axially. The movement device can comprise at least one actuator, such as a servo-controlled actuator. The movement device can comprise at least one screwjack or similar mechanism.

The planer can further comprise a controller linked to the movement device and configured to send signals to the movement device. The planer can comprise at least one sensor for detecting an axial position of the at least one planing head along the rotational axis. The sensor can comprise a linear transducer.

In some implementations, the at least one planing head is shiftable by a predetermined distance less than a dimension of the planing head in the axial direction. In some implementations, the at least one planing head is continuously shiftable by a desired distance.

According to another implementation, a planing head for a planer comprises a body having an outer surface with blade spaces configured to hold a plurality of spaced apart blades, first and second opposing ends separated by the outer surface and a rotation axis passing through the first and second ends. The planing head also comprises at least first and second axial sections defined along a length of the body parallel to the rotation axis, each of the first and separate axial sections being positionable in a planing machine for contact with a workpiece by shifting the body axially.

In some implementations, the first and second axial sections are adjacent each other. In some implementations, the first and second axial sections overlap each other at least partially.

In some implementations, the blade spaces extend continuously from the first axial region to the second axial region. In some implementations, the blade spaces for the first axial region of the body are separated from the blade spaces for the second axial region of the body.

According to another implementation, a planer comprises a support, at least one first planing head, at least one second planing head and a movement device. The at least one first planing head is rotatably mounted to the support and has a first rotation axis. The first planing head is positionable during operation to contact a first surface of a workpiece. The at least one second planing head is rotatably mounted to the support and has a second rotation axis generally parallel to the first rotation axis. The second planing head is positionable during operation to contact a second surface of the workpiece opposite the first surface of the workpiece. The movement device is coupled to the at least one first planing head and the at least one second planing head, the movement device is controllable to move at least one of the first planing head along the first rotation axis or the second planing head along the second rotation axis to change the axial sections of the first planing head or the second planing head, respectively, that are positioned to contact the workpiece.

The planer can comprise a control circuit connected to the movement device and responsive to commands from a user to send control signals to cause the movement device to move at least one of the first planing head or the second planing head.

Other features will be apparent from the accompanying drawings and the detailed description that follows.

### BRIEF DESCRIPTION OF THE DRAWINGS

FIG. 1A is a perspective view of a planer shown schematically that has two axially shiftable planing heads positioned in a horizontal orientation.

FIG. 1B is an end view of the planer shown in FIG. 1A.

FIG. 2A is a perspective view of the planer of FIGS. 1A and 1B with the two planing heads shown in axially shifted positions.

FIG. 2B is an end view of the planer shown in FIG. 2A.

FIG. 2C is a plan view of a planer illustrating movement of the planing head in only the axial direction during its shifting.

FIG. 2D is a plan view of an alternative arrangement illustrating movement of the planing head in two or more directions, with a resulting axial component in or parallel to the axial direction as it is shifted.

FIG. 3A is a perspective view of a planer shown schematically that has four axially shiftable planing heads, including a pair positioned in a horizontal orientation and a pair positioned in another orientation (in this case, a vertical orientation).

FIG. 3B is an end view of the planer shown in FIG. 1A.

FIG. 4A is a perspective view of the planer of FIGS. 3A and 3B with the four planing heads shown in axially shifted positions.

FIG. 4B is an end view of the planer shown in FIG. 4A.

FIG. 5 is a perspective view of a planer shown schematically that has axially shiftable planing heads and is controllable from an operator console positioned outside of an enclosure that surrounds the planer.

FIG. 6 is a perspective view of a planer according to another implementation.

FIG. 7 is another perspective view of the planer of FIG. 6.

FIG. 8 is another perspective view of the planer of FIG. 6.

FIG. 9 is a block diagram showing structural and logical connections between several components of the planer.

FIG. 10 is a flow chart of an exemplary method.

FIG. 11 is a block diagram of an exemplary computing environment suitable for implementing the technologies described herein.

### DETAILED DESCRIPTION

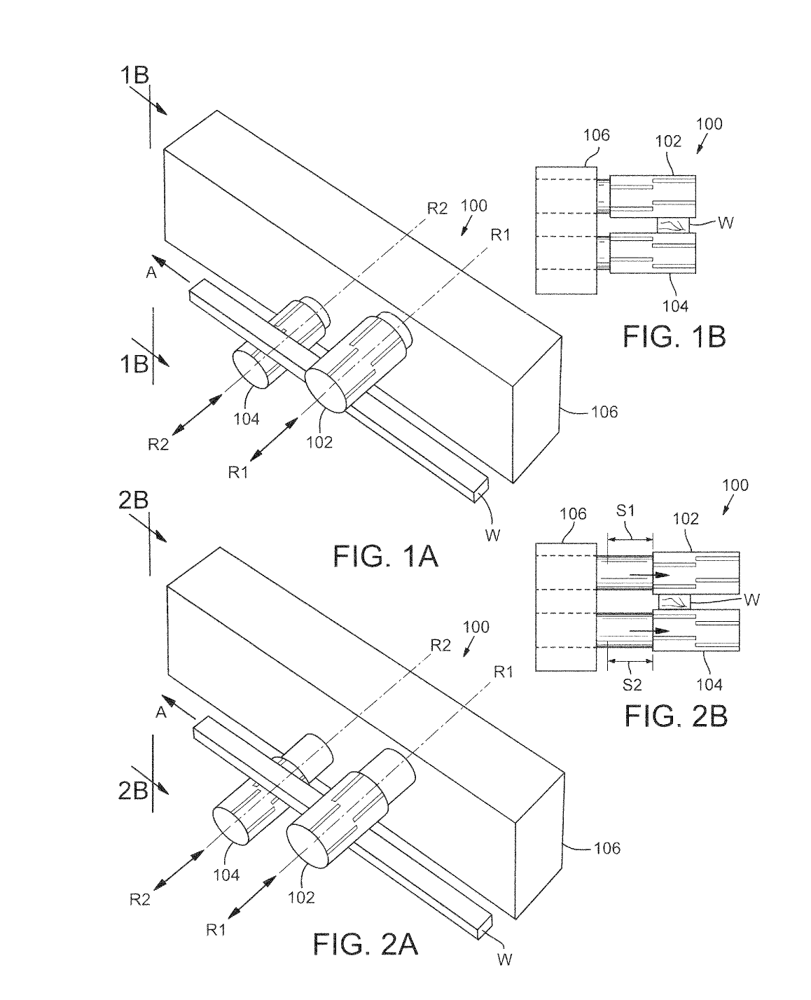

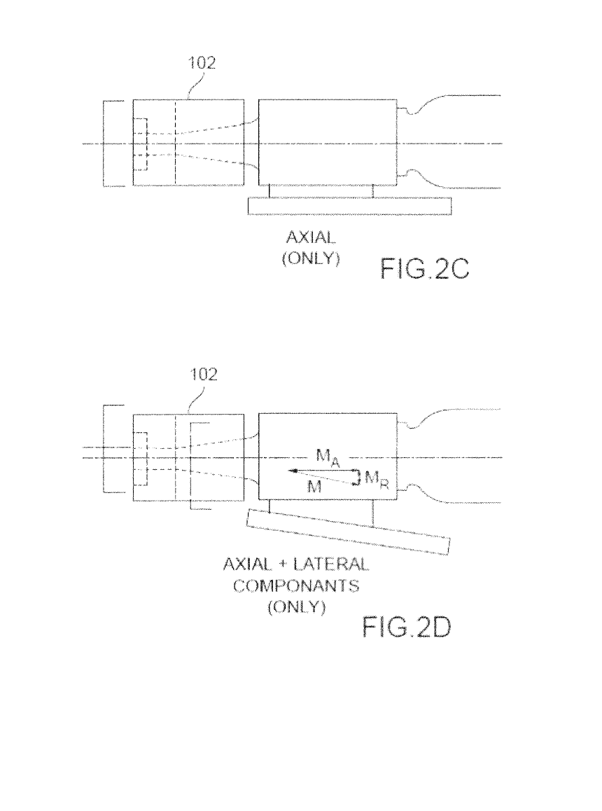

Referring to FIGS. 1A, 1B, 2A and 2B, a planer 100 having at least one rotatable planing head that is axially shiftable along its rotation axis is shown schematically. In the orientation shown in these figures, the shifting in the axial direction can also be referred to as “lateral” shifting. Further, as used herein, the terms “axial” and “axially” as used to describe the shifting or moving of planing heads refer to structures that have a component of their motion in the axial direction or in a direction parallel to the axial direction.

Referring to FIGS. 1A and 1B, the planer 100 has a first planing head 102 that is mounted for rotation about a first rotation axis R1, and a second planing head 104 that is mounted for rotation about a second rotation axis R2. The planing heads 102, 104 are rotatably supported by a frame 106 or other suitable structure. A workpiece W, such as a piece of lumber, is shown being drawn in the direction A through the planing heads 102, 104. In the illustrated example, the first planing head 102 is in contact with an upper surface of the workpiece W, and the second planing head 104 is in contact with an opposite lower surface of the workpiece. In the illustrated example, the planing heads 102, 104 are independently shiftable inwardly (toward the frame 106) or outwardly (away from the frame 106) as indicated by the arrows on each respective axis R1, R2.

FIGS. 2A and 2B show the planing heads 102, 104 in second positions that are axially shifted from positions shown in FIGS. 1A and 1B (which can be referred to as “first positions”). As can be seen in the drawings, the planing heads 102 and 104 have been shifted or moved axially outward along their respective axes R1, R2. The first planing head 102 has been axially shifted by a distance S1 (FIG. 2B). The second planing head 104 has been axially shifted by a distance S2 (FIG. 2B). As stated, each planing head can be movable independently of other planing heads, so the distances and/or directions of the axial shifts may be the same or may vary.

Among other reasons, one or both of the planing heads 102, 104 may be moved from its first position shown in FIG. 1A to an axially shifted position, such as its second position shown in FIG. 2A, e.g., to improve the operation of the planer 100. For example, if a current section of a planing head becomes dull or damaged, it may be shifted inwardly or outwardly to use a different axial section (also referred to as an axial length or axial segment). The different axial section may include blades that are sharper or otherwise in better condition, or a different type of blade.

FIG. 2C is an end elevation view of an embodiment of a planer in which the axial shifting of the planing head 102 takes place along the axis of rotation R1, and the axis of rotation R1 has a fixed position. That is, the only motion of the planing head 102 in shifting to a new position is translation along the rotation axis R1. In some implementations, such as is illustrated in FIG. 2D, however, the planing head 102 may move in a movement direction that is not along or parallel to the axis of rotation R1, but has a component of its motion that is along or parallel to the axis of rotation. For example, the movement direction M (which might be defined by an inclined plane 152) has an axial component M_{A} in or parallel to the axial direction and a radial component M_{R} that is not in or parallel to the axial component. Thus, the axis of rotation R1 for the planing head 102 changes positions as the planing head 102 is moved along the movement direction M.

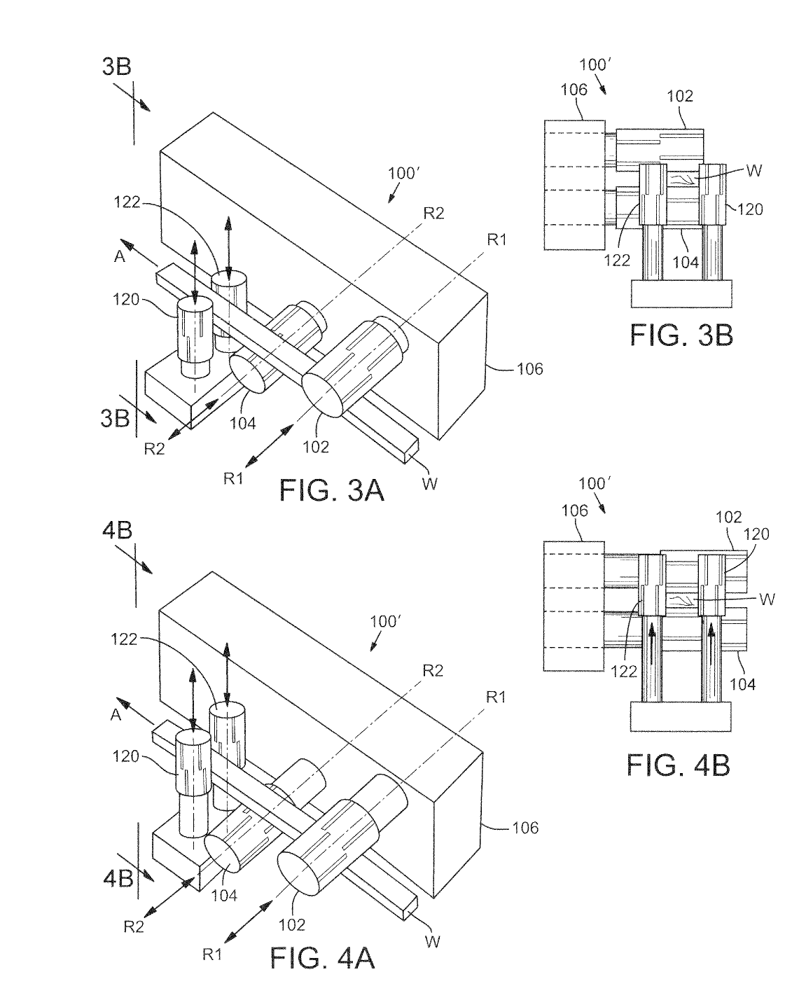

FIGS. 3A, 3B, 4A and 4B show another representative embodiment of a planer 100′ having multiple planing heads shiftable along their axes, including at least two planing heads positioned to rotate about axes that are not parallel. As shown, at least one of the planing heads 102, 104 positioned horizontally can be axially shiftable, and there can be at least one additional planing head positioned in a different orientation, such as one of the planing heads 120, 122 positioned vertically, that is also axially shiftable. It is of course possible to have the planing heads arranged in orientations other than horizontal and/or vertical. It is possible for one of each pair of planing heads to be axially shiftable, or each of the pair can be axially shiftable.

In the specific example of FIGS. 4A and 4B, each of the planing heads 102, 104 has been axially shifted (i.e., outwardly) by a first distance, and each of the planing heads 120, 122 has been axially shifted (i.e., upwardly) by a second distance. In other examples, only one of the planing heads is shifted, or fewer than all planing heads are shifted.

The planing head 102 is arranged as a top head, with the planing head 104 being arranged as a bottom head and to follow the top head. Referring to FIGS. 3A-4B, the planing heads 120, 122 are arranged to oppose each other and as side planing heads.

In the drawings, the planing heads are shown schematically to have two distinct axial segments or sections for purposes of illustration. It is possible, however, for the axially shiftable planing heads to be configured with more than two distinct axial sections, or even to have a continuous configuration without multiple axial sections.

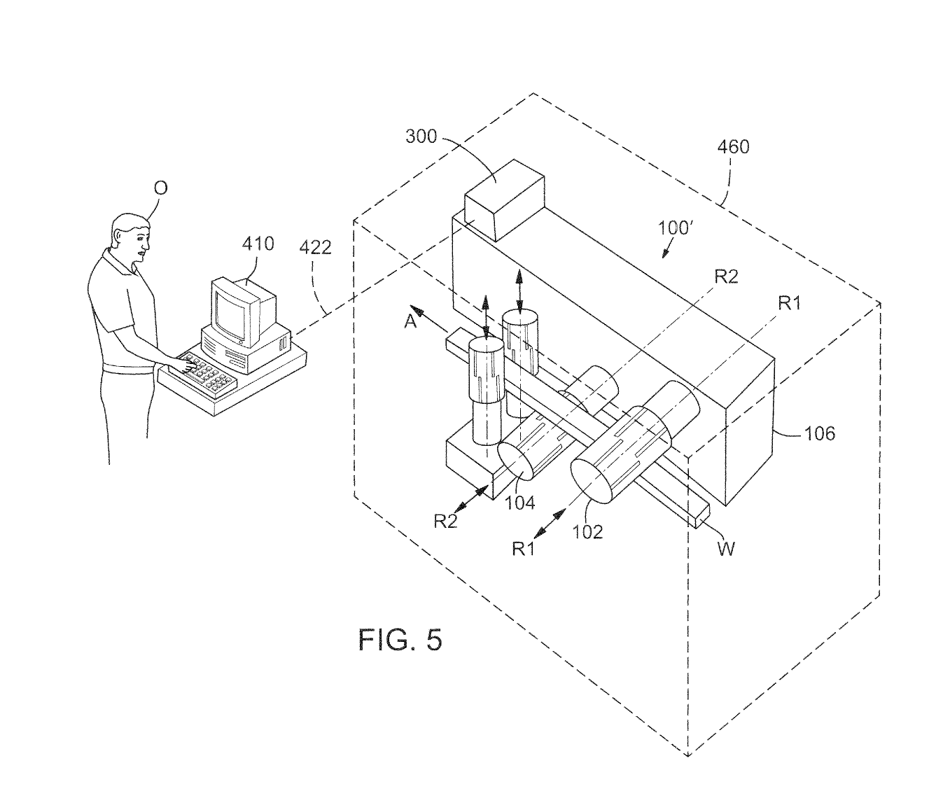

FIG. 5 is a perspective view of the planer 100′ shown in a representative operating environment. As indicated schematically, the planer 100′ is at least partially enclosed by an enclosure 460. During planing operations, wood debris and possibly other objects can be propelled or ejected from the planer at considerable speed. Thus, such debris is potentially a source of injury to workers and creates a larger area to be cleaned if not contained. Therefore, the enclosure 460 can be configured to separate one or more sides of the planer from surrounding areas. The enclosure 460 can have solid or mesh sides, and can be fitted with doors and/or other openings to provide access.

As illustrated in FIG. 5, a terminal 410 connected by a control line 422 to the planer's controller 300 can be accessed by an operator O to control operation of the planer 100′ from outside of the enclosure 460. Further details of the control of the planer are described below.

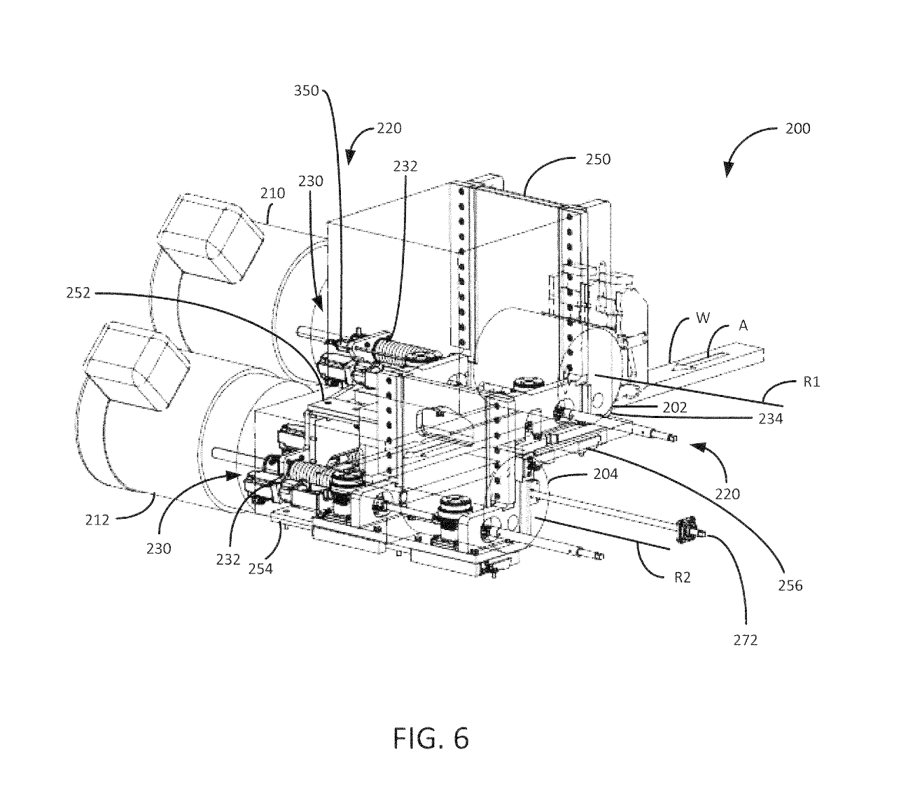

FIGS. 6, 7 and 8 are different perspective views of a portion of a planer 200 having at least one axially shiftable planing head according to another implementation. Similar to the implementations in FIGS. 1A-2B and FIGS. 3A-4B, the planer 200 has a first axially shiftable planing head 202 that is mounted for rotation about a first rotation axis R1, and a second planing head 204 that is mounted for rotation about a second rotation axis R2. A workpiece W, such as a piece of lumber, is shown being moved in the direction A through the rotating planing heads 202, 204. The first planing head 202 has a shaft (which has been omitted from the drawing for clarity) that extends along the first rotation axis R1 and is driven by a first motor 210. Similarly, the second planing head 204 has a shaft (which has also been omitted from the drawing for clarity) that extends along the first rotation axis R2 and is driven by a second motor 212.

There is a movement assembly 220 that is controllable to move or shift at least the first planing head 202 axially, i.e., in the direction of its rotation axis R1, either inwardly or outwardly. The movement assembly 220 includes servo-driven actuators 230 controllable to translate and urge the planing head 202 axially by a desired distance. In the illustrated implementation, the actuators are screw jacks 232, but it would also be possible to use other types of actuators. In the illustrated implementation, the movement assembly 220 is configured to move the second planing head 204 simultaneously with moving the first planing head 102, but independently movable planing head arrangements are also appropriate in some circumstances.

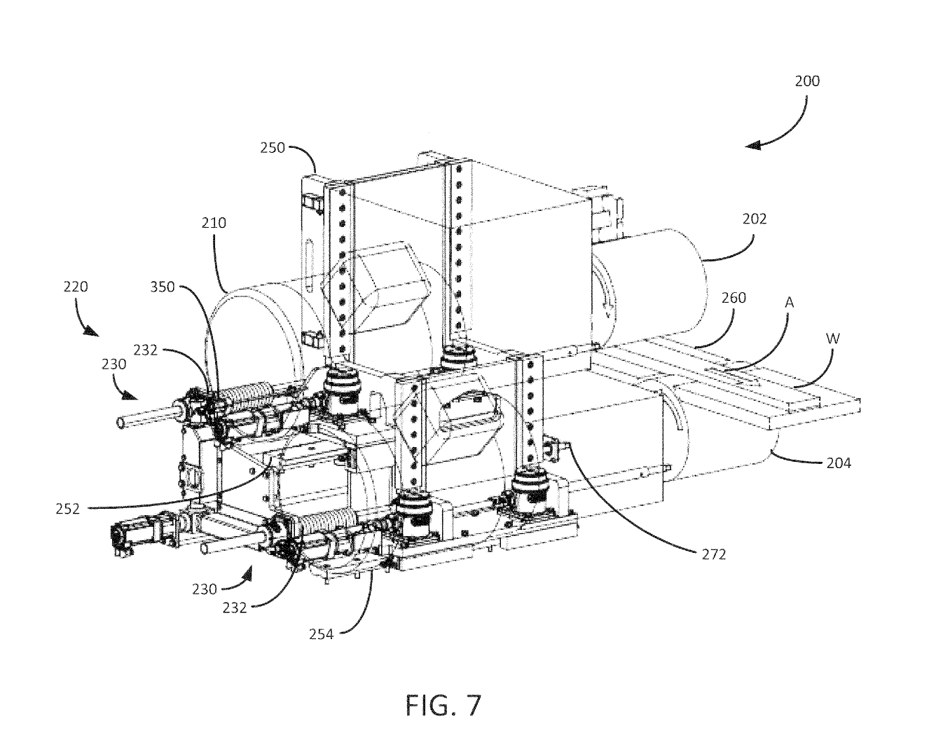

In the illustrated implementation, the screw jacks 232 cause a portion of the planer 200 that supports the planing heads 202, 204, referred to as a stand 250, to move axially, such as along one or more guiding surfaces, e.g., ways 252, 254, 256. In this way, the planing heads 202, 204 are moved axially. As best seen in FIG. 6, there is a chipbreaker shoe 234 that is engaged, such as by using a solenoid valve, to retain the workpiece W in a desired position and disengaged when the planing head 202 is moved axially along the ways 252, 254, 256. The chipbreaker shoe 234 holds the workpiece W against an opposing surface (such as the support) to break any long splinters of material that may occur if the material is not cleanly cut by the planer head blades. There can be a single chipbreaker shoe 234 for multiple planing heads as shown, or multiple chipbreaker shoes can be used. Referring to FIG. 7, the planer 200 can have a plate 260 upon which the workpiece W is guided along some or all of its path between the planing heads 202, 204. There is at least one linear transducer 350 that is configured to detect position information of one or more of the planing heads and to send that information to one or more control components, as is described below in greater detail.

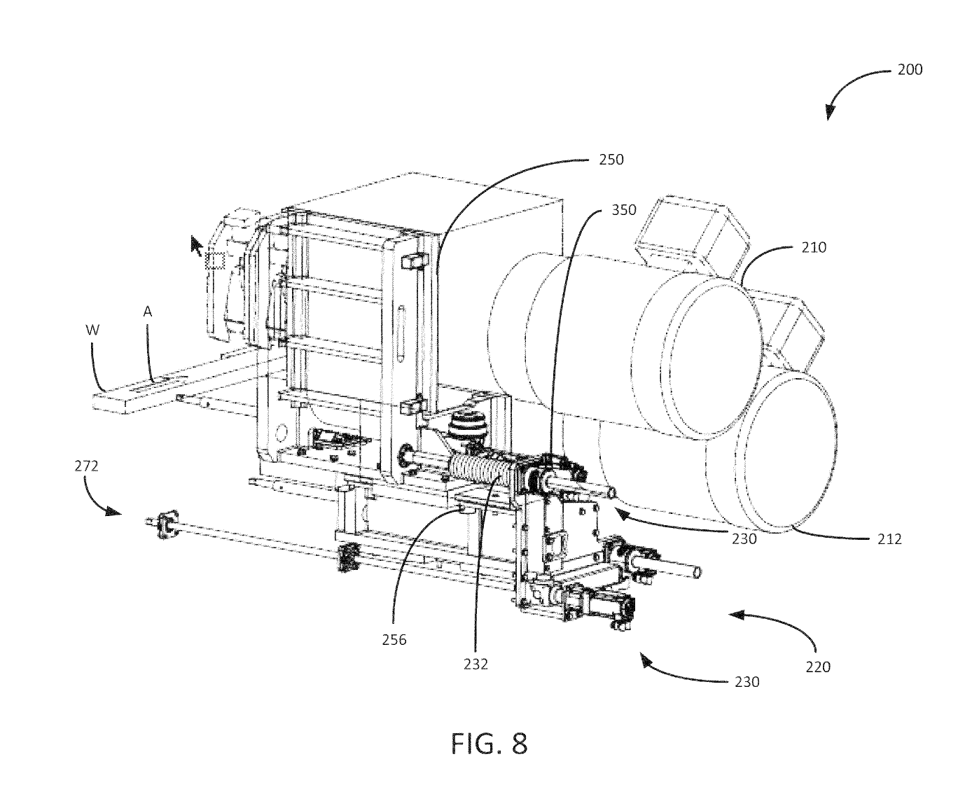

FIG. 8 is another view of the planer 200 from a different perspective and omitting some structure compared to FIGS. 6 and 7 for clarity.

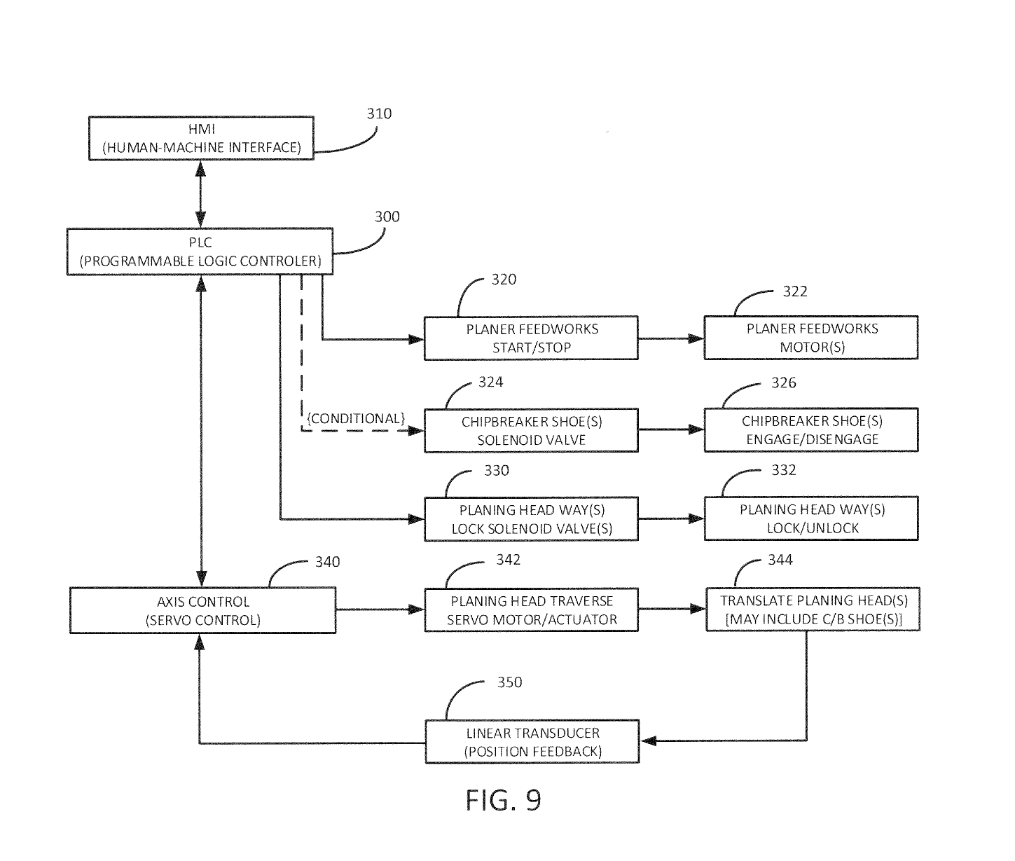

FIG. 9 is a combined block diagram showing functional and logical relationships between several different components of a planer relating to its control, including axial movement of one or more planing heads. There is a controller or processor, such as the controller 300. The controller 300 may be a programmable logic controller (PLC) or other suitable type of controller. A human-machine interface 310, such as a display and an input device similar to the terminal 410, is connected to the controller 300. The controller is linked to a feedworks start/stop switch 320 (or other control), which allows one or more motors 322 for the planing feedworks motor(s)) to control the drive for the workpiece fed through the planing heads as desired.

The controller is also linked to a chipbreaker actuator solenoid valve 324 or other similar device. Signals from the controller 300 cause the solenoid valve 324 to change state and engage or disengage the chipbreaker shoe(s) 326.

The controller is also linked to a stand way solenoid valve 330. Signals from the controller cause the stand way solenoid valve 330 to change state and to engage or disengage one or more locks for the ways 252, 254, 256, thereby locking or unlocking the stand from movement in the axial direction.

The controller is also linked to a servo control 340 (or axis control). The servo control 340 controls one or more servo motor(s) and actuator(s) 342 that are operable to change the axial position of the planing head(s). As indicated in block 344, the servo motors and actuators 342 are controllable to cause the planing heads to translate (such as by executing a “move” command, either inwardly or outwardly). In some implementations, any chipbreaker shoe(s) that are present move with the planing head(s).

In some implementations, the axial position of the planing head(s) is detected by a suitable sensor, such as the linear transducer 350, and the position information is fed back to the servo control 340 and to the controller 300 to assist in controlling movement of the planing head(s).

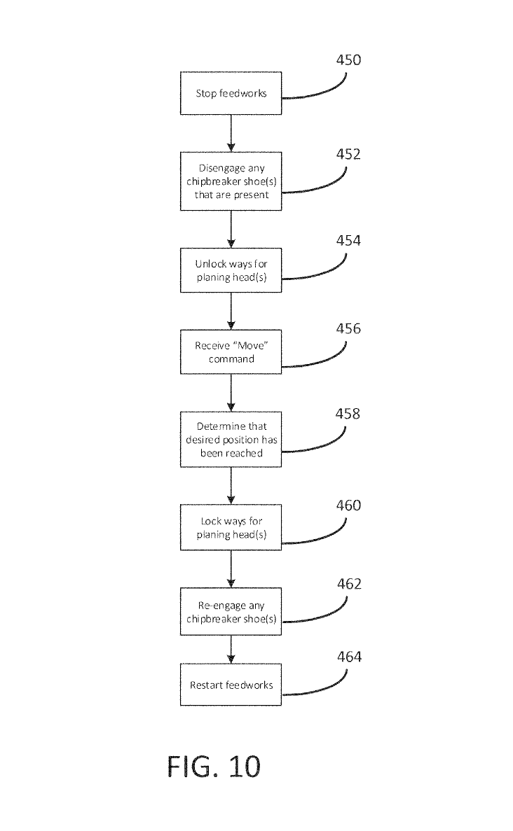

According to a representative method implementation as shown in the flow chart of FIG. 10, at a time when it is desired to shift one or more of the planing heads, the feedworks are stopped (Step 450). If any chipbreaker shoe(s) are engaged, it is disengaged (Step 452). In Step 454, the ways for the planing head(s) are unlocked. In Step 456, the controller responds to a “Move” command input by an operator at the terminal 410 to cause the planing head(s) to move as desired. In Step 458, it is determined that the desired position has been reached (e.g., by feedback from the linear transducer). In Step 460, the planing head ways are locked to secure the planing head(s) in place. In Step 462, the chipbreaker shoe(s) are re-engaged. In Step 464, the feedworks is restarted.

Thus, one of or more of the planing heads can be controllably shifted relatively quickly to ensure smooth overall operation with minimal downtime. As described, the shifting of the planing heads preferably takes place while the planer is not in its normal production mode, and with no lumber engaged with the planning head(s). In some implementations, an operator issues commands to control the planer, such as from a remote location, e.g., from outside of an enclosure. Optionally, the operator can be provided with visual indications of the steps taking place (e.g., on a display), including an indication of the position of planing heads, such as while they are being moved.

### Exemplary Computing Environment

The techniques and solutions described herein, particularly relating to control of the planer, can be performed by software, hardware, or both as elements of a computing environment, such as one or more computing devices. For example, computing devices include server computers (including PLC server computers), desktop computers, laptop computers, notebook computers, handheld devices, netbooks, tablet devices, mobile devices, PDAs, and other types of computing devices.

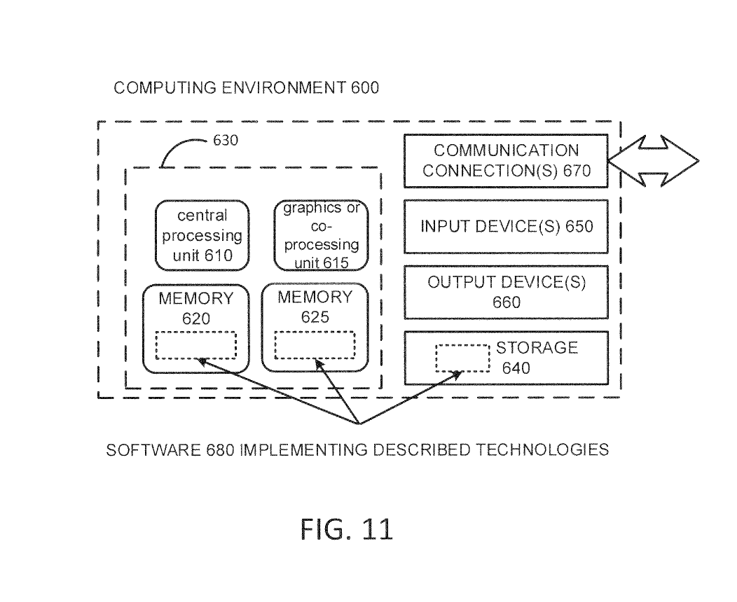

FIG. 11 illustrates a generalized example of a suitable computing environment 600 in which the described technologies can be implemented. The computing environment 600 is not intended to suggest any limitation as to scope of use or functionality, as the technologies may be implemented in diverse general-purpose or special-purpose computing environments. For example, the disclosed technology may be implemented using a computing device comprising a processing unit, memory, and storage storing computer-executable instructions implementing the enterprise computing platform technologies described herein. The disclosed technology may also be implemented with other computer system configurations, including hand held devices, multiprocessor systems, microprocessor-based or programmable consumer electronics, network PCs, minicomputers, mainframe computers, a collection of client/server systems, and the like. The disclosed technology may also be practiced in distributed computing environments where tasks are performed by remote processing devices that are linked through a communications network. In a distributed computing environment, programs and program modules may be located in both local and remote memory storage devices.

With reference to FIG. 11, the computing environment 900 includes at least one processing unit 910 coupled to memory 920. In FIG. 11, this basic configuration 930 is included within a dashed line. The processing unit 910 executes computer-executable instructions and may be a real or a virtual processor (e.g., executing on one or more hardware processors). In a multi-processing system, multiple processing units execute computer-executable instructions to increase processing power. The memory 920 may be volatile memory (e.g., registers, cache, RAM), non-volatile memory (e.g., ROM, EEPROM, flash memory, etc.), or some combination of the two. The memory 920 can store software 980 implementing any of the technologies described herein.

A computing environment may have additional features. For example, the computing environment 900 includes storage 940, one or more input devices 950, one or more output devices 960, and one or more communication connections 970. An interconnection mechanism (not shown) such as a bus, controller, or network interconnects the components of the computing environment 900. Typically, operating system software (not shown) provides an operating environment for other software executing in the computing environment 900, and coordinates activities of the components of the computing environment 600.

The storage 940 may be removable or non-removable, and includes magnetic disks, magnetic tapes or cassettes, CD-ROMs, CD-RWs, DVDs, or any other computer-readable media which can be used to store information and which can be accessed within the computing environment 900. The storage 940 can store software 980 containing instructions for any of the technologies described herein.

The input device(s) 950 may be a touch input device such as a keyboard, mouse, pen, or trackball, a voice input device, a scanning device, or another device that provides input to the computing environment 900. For audio, the input device(s) 950 may be a sound card or similar device that accepts audio input in analog or digital form, or a CD-ROM reader that provides audio samples to the computing environment. The output device(s) 960 may be a display, printer, speaker, CD-writer, relay, motion control card, or another device that provides output from the computing environment 600.

The communication connection(s) 970 enable communication over a communication mechanism to another computing entity. The communication mechanism conveys information such as computer-executable instructions, audio/video or other information, or other data. By way of example, and not limitation, communication mechanisms include wired or wireless techniques implemented with an electrical, optical, RF, infrared, acoustic, or other carrier.

The techniques herein can be described in the general context of computer-executable instructions, such as those included in program modules, being executed in a computing environment on a target real or virtual processor. Generally, program modules include routines, programs, libraries, objects, classes, components, data structures, etc., that perform particular tasks or implement particular abstract data types. The functionality of the program modules may be combined or split between program modules as desired in various embodiments. Computer-executable instructions for program modules may be executed within a local or distributed computing environment. Any of the computer-readable media herein can be non-transitory (e.g., memory, magnetic storage, optical storage, or the like).

Any of the storing actions described herein can be implemented by storing in one or more computer-readable media (e.g., computer-readable storage media or other tangible media).

Any of the things described as stored can be stored in one or more computer-readable media (e.g., computer-readable storage media or other tangible media).

Any of the methods described herein can be implemented by computer-executable instructions in (e.g., encoded on) one or more computer-readable media (e.g., computer-readable storage media or other tangible media). Such instructions can cause a computer to perform the method. The technologies described herein can be implemented in a variety of programming languages.

Any of the methods described herein can be implemented by computer-executable instructions stored in one or more computer-readable storage devices (e.g., memory, magnetic storage, optical storage, or the like). Such instructions can cause a computer to perform the method.

### Alternatives

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the following claims. I therefore claim all that comes within the scope and spirit of the claims.

What is claimed is:

1. A planer for lumber, comprising:
a support; and
at least one planing head rotatably mounted to the support and positionable to contact a surface of a workpiece, the at least one planing head having a rotation axis and being controllably shiftable to move from a first cutting position at a first axial position to a second cutting position at a second axial position.

2. The planer of claim 1, wherein the at least one planing head is a first planing head, further comprising a second planing head, and wherein the first and second planing heads are shiftable axially along respective first and second rotation axes from respective first cutting positions to respective second cutting positions.

3. The planer of claim 2, wherein the first planing head and the second planing head are independently shiftable relative to each other.

4. The planer of claim 1, wherein the at least one planing head is a first planing head, further comprising a second planing head, the first and second planing heads comprising a first axially shiftable planing head pair, further comprising a second axially shiftable planing head pair, and wherein rotation axes for the second axially shiftable planing head pair are not parallel to rotation axes for the first axially shiftable planing head pair.

5. The planer of claim 4, wherein the first axially shiftable planing head pair comprises a top planing head and a bottom planing head, and wherein the second axially shiftable planing head pair comprises side planing heads.

6. The planer of claim 1, wherein the first axial position and the second axial position are offset from each other in at least one direction perpendicular to the rotation axis.

7. The planer of claim 1, further comprising a movement device coupled to the at least one planing head and controllable to shift the at least one planing head axially.

8. The planer of claim 7, wherein the movement device comprises at least one servo-controlled actuator or at least one screwjack.

9. The planer of claim 7, further comprising a controller linked to the movement device and configured to send signals to the movement device.

10. The planer of claim 9, further comprising at least one sensor for detecting an axial position of the at least one planing head.

11. The planer of claim 10, wherein the at least one sensor comprises a linear transducer.

12. The planer of claim 1, further comprising an operator station located remotely from the planer and having operator controls linked to the planer, the operator controls being responsive to inputs from an operator to control the planer.

13. The planer of claim 1, wherein the at least one planing head is continuously shiftable by a desired distance.

14. A planing head for a planer, comprising:
a body having an outer surface with blade spaces configured to hold a plurality of spaced apart blades, first and second opposing ends separated by the outer surface and a rotation axis passing through the first and second ends; and
at least first and second axial sections defined along a length of the body parallel to the rotation axis, each of the first and second axial section being positionable in a planing machine for contact with a workpiece by shifting the body axially.

15. The planing head of claim 14, wherein the first and second axial sections are adjacent each other.

16. The planing head of claim 14, wherein the first and second axial sections overlap each other at least partially.

17. The planing head of claim 14, wherein the blade spaces extend continuously from the first axial section to the second axial section.

18. The planing head of claim 14, wherein the blade spaces for the first axial section of the body are separated from the blade spaces for the second axial section of the body.

19. A planer, comprising:
a support;
at least a first planing head rotatably mounted to the support and having a first rotation axis, the first planing head being positionable during operation to contact a first surface of a workpiece;
at least a second planing head rotatably mounted to the support and having a second rotation axis generally parallel to the first rotation axis, the second planing head being positionable during operation to contact a second surface of the workpiece opposite the first surface of the workpiece;
a movement device coupled to the first planing head and second planing head, the movement device being remotely controllable to move at least one of the first planing head or the second planing head from a respective first axial position to a respective second axial to change an axial section of the first planing head or the second planing head, respectively, that is positioned to contact the workpiece.

20. The planer of claim 19, further comprising a control circuit connected to the movement device and responsive to commands from a user to send control signals to cause the movement device to move at least one of the first planing head or the second planing head.
